(19) United States
(12) Patent Application Publication
(10) Pub. No.: US 2026/0273419 A1
(43) Pub. Date: Sep. 17, 2026

(54) UPDATING APPLICATION BINARY DURING VIDEO GAME EXECUTION

(71) Applicant: SONY INTERACTIVE ENTERTAINMENT INC., Tokyo (JP)

(72) Inventors: David Ross Coles, Mission Viejo, CA (US); Steve Agoston, Manhattan Beach, CA (US)

(21) Appl. No.: 19/076,858

(22) Filed: Mar. 11, 2025

(51) Int. Cl. A63F 13/69

(52) U.S. Cl. CPC A63F 13/69

(57) ABSTRACT

Techniques for updating application binary during video game execution are provided. In an example, a computer system executes a video game application based on a binary including a first compiled program code and a second compiled program code. The computer system receives, while the video game application executes, a program code patch that includes a third compiled program code to replace the first or second compiled program code or to be added to the binary. The computer system updates the binary to include the program code patch while the video game application continues to execute.

### BACKGROUND

Video games can be an incredibly immersive form of entertainment. Whether played alone or in groups over the internet, video games can be challenging and engaging. But on occasion, the action can stop if necessity while graphics are loaded, new players are added, and other similar reasons. This stoppage can be jarring and discontinuous with the high level of interaction that occurs during a game.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system, according to embodiments of the present disclosure.

FIG. 2 illustrates an example of updating binaries for instances of a video game application while the instances are executing, according to embodiments of the present disclosure.

FIG. 3 illustrates an example of updating a binary for a single instance of a video game application while multiple instances are executing, according to embodiments of the present disclosure.

FIG. 4 illustrates an example of a development environment for video game applications, according to embodiments of the present disclosure.

FIG. 5 illustrates an example of a diagram for video game binary generation and patching from source code assets, according to embodiments of the present disclosure.

FIG. 6 illustrates an example flow for a process of updating application binary during video game execution, according to embodiments of the present disclosure.

FIG. 7 illustrates an example of a hardware system suitable for implementing a computer system, according to embodiments of the present disclosure.

In the appended figures, similar components and/or features may have the same reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure are directed to, among other things, updating application binary during video game execution. A computer system, such as a video game server, can execute a video game application based on a binary. The binary includes compiled program codes that are each an executable compilation unit representing a source code asset of the video game application. So, each compiled program code corresponds to a portion of the binary. While the video game application executes, the computer system can receive a program code patch that includes an additional compiled program code that is to replace a compiled program code included in the binary or that is to be added to the binary. The computer system can then update the binary to include the program code patch while the video game application continues to execute. This is distinct from a plugin system or similar where a developer builds in a feature to add or replace a specific piece of functionality at runtime. The advantage here is that there is no need to deliberately add these fixed extension points. So, the techniques herein can be implemented on pre-existing software without having to retrofit it with a plugin system or similar.

To illustrate, consider the example of a user interacting with a gaming console via an external controller, such as a game console controller, to play a video game application. The gaming console can provide graphical game images for the video game application on a screen. The video game application can be streamed by the video game console from a video game server. The video game application executes based on a binary that includes a compilation unit for a water texture in the video game application and a compilation unit for boss logic for a non-player character that the user plays against in the video game application. The compilation units are cached at a storage server along with a dependency graph and metadata for the compilation units of the video game application. While the video game application is executing, the video game server can receive a patch for the video game application that includes new boss logic for the non-player character. The patch can include a new compilation unit that is to replace the compilation unit for the boss logic in the binary. Upon determining that the video game execution is not currently using the boss logic so as to not disrupt execution of the video game application, the server unlinks the original boss logic compilation unit from the binary and links the new boss logic compilation unit in the binary. This may be done while the original boss logic compilation unit is still in use by holding both compilation units in memory simultaneously. Old users are directed to the old code, and new users are directed to the new code. The server uses the dependency graph and metadata to determine how to link the new boss logic compilation unit in the binary. So, when the video game execution needs to use the boss logic (e.g., corresponding to the user playing against the non-player character), the new boss logic is executed.

Embodiments of the present disclosure can provide several advantages over existing video game systems presenting video game content. For example, by patching a binary by sending only a new portion of compiled program code involved in the patch to a video game application at run-time, computational demands can be reduced that can arise from generating and sending a complete binary any time a change is made to a source code asset for the video game application. In addition, caching compiled program codes can provide efficient retrieval and incorporation of compiled program codes that are to be included in the binary. This patching can be performed at run-time by a linker associated with the video game application, so the execution of the video game application is not disrupted. As such, user experience can also be improved by reducing disruption caused by switching out an entire binary since the video game application is not playable during this time.

In the interest of clarity of explanation, the embodiments can be described in connection with a video game system including a video game console. However, the embodiments are not limited as such and can similarly apply to any other type of a computer system.

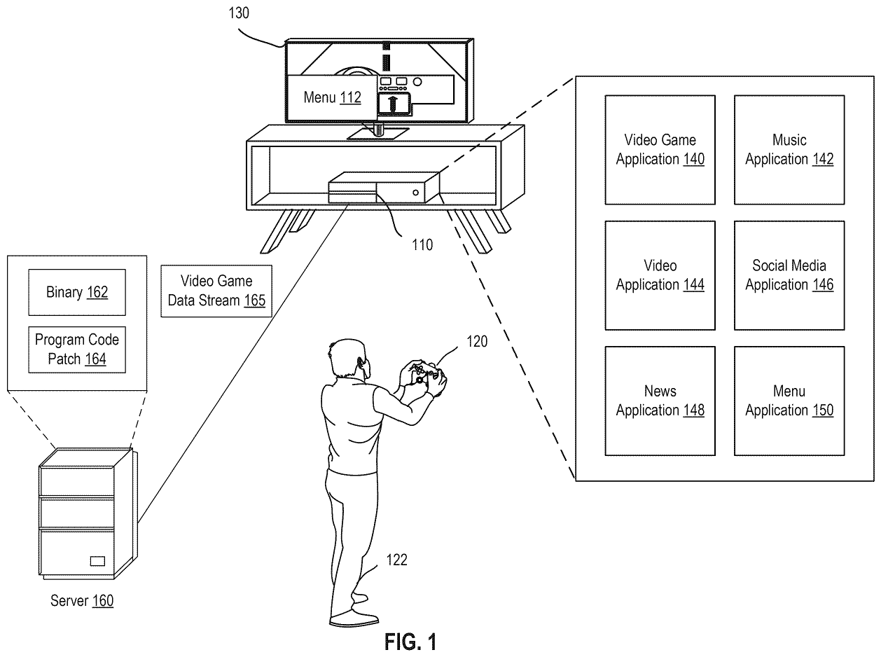

FIG. 1 illustrates a computer system, according to an embodiment of the present disclosure. As illustrated, the computer system includes a video game console 110, a video game controller 120, and a display 130. The computer system may also include a backend system, such as cloud servers, that is communicatively coupled with the video game console 110. As an example, the backend system can include a server 160. The video game console 110 is communicatively coupled with the video game controller 120 (e.g., over a wireless network) and with the display 130 (e.g., over a communications bus), in addition to being communicatively coupled with the server 160 (e.g., over a public network such as the Internet). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login).

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

In one embodiment, the video game application 140 is a cloud-based application. The cloud-based application can have components executing remotely on a server 160 (e.g., part of an online cloud service) and components executing locally. The server 160 components can include, but need not be limited to, a rendering engine. The local components can include, but need not limited to, a user interface. As such, the actual execution of the cloud-based application can occur remotely from the video game console 110 on the server 160, whereby the output of the execution can be streamed (e.g., as video and audio data of a video game data stream 165) to the user interface for presentation at the display 130.

The server 160 can also include a processor and a memory (e.g., a non-transitory computer-readable storage medium) storing computer-readable instructions that can be executed by the processor and that, upon execution by the processor, cause the server 160 to perform operations related to various applications. In particular, the computer-readable instructions can correspond to program codes for various applications of the server 160. The server 160 may control execution of the applications of the video game console 110, such as controlling execution of the video game application 140. The server 160 can include a binary 162 of the video game application 140 that includes compiled program codes, and the video game application 140 can be executed by the video game console 110 based on the binary 162. During execution of the video game application 140, the server 160 can receive a program code patch 164 for the video game application 140. The program code patch 164 can correspond to a portion of the binary 162 that is to be replaced or added for the video game application 140. As the video game application 140 continues executing, the binary 162 can be updated to include the program code patch 164. In some instances, the video game application 140 is executing locally on the video game console 110 instead of the server 160, so the binary 162 is local to the video game console 162. In this case, the server 160 can still send the program code patch 164, but then the video game console 110 makes the seamless update to the binary 162.

Although FIG. 1 illustrates that the different applications are executed on the video game console 110, the embodiments of the present disclosure are not limited as such. Instead, the applications can be executed on the backend system (e.g., the server 160) and/or their execution can be distributed between the video game console 110 and the backend system.

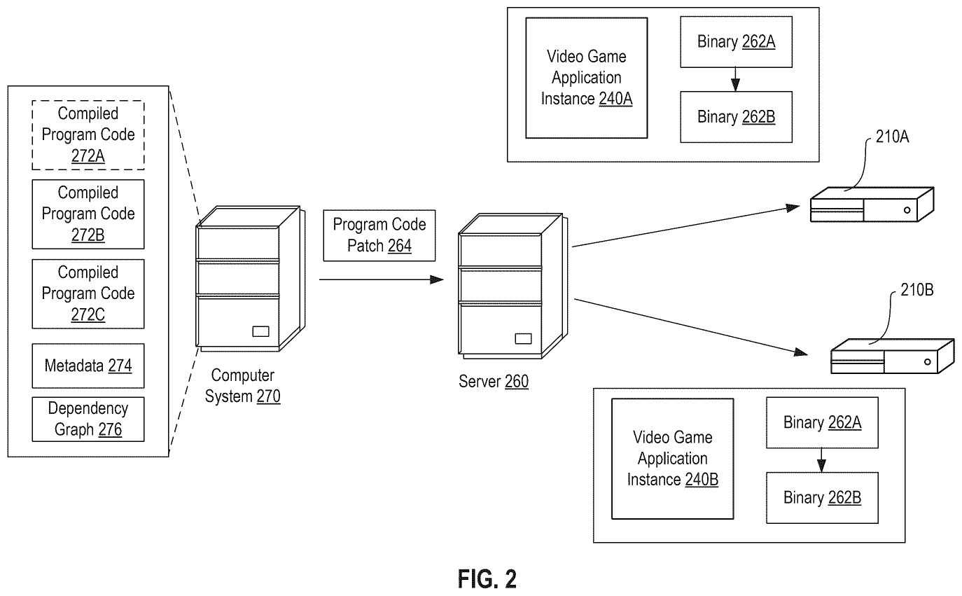

FIG. 2 illustrates an example of updating binaries for instances of a video game application while the instances are executing, according to embodiments of the present disclosure. A server 260, which is an example of the server 160 in FIG. 1 can include a binary 262A for a video game application (e.g., video game application 140 in FIG. 1). The server 260 can execute multiple instances of the video game application. For example, in FIG. 2 the server 260 is illustrated as executing video game application instance 240A at video game console 210A and video game application instance 240B at video game console 210B.

Each of the video game application instances 240A-240B can execute based on binary 262A, which includes compiled program codes. The compiled program codes can be cached by a computer system 270 that is communicatively coupled to the server 260. In an example, the binary 262A can initially include compiled program codes 272A-272B. Compiled program code 272A corresponds to a first portion of executable code of the binary 262A, and compiled program code 272B corresponds to a second portion of executable code of the binary 262A. Both of the compiled program codes 272A-272B can be object files generated (e.g., compiled) by a compiler that is remote from the video game application instances 240A-240B. The compiled program codes 272A-272B may be compiled from source code assets that are not executable without first being compiled. Each source code asset (and corresponding compiled program code) can be associated with a particular attribute of the video game application instances 240A-240B. For example, the attributes may involve visual attributes (e.g., character logic, environment logic, shaders, etc.), audio attributes (e.g., sound effects, music, voiceovers, etc.), and any other suitable attributes such as animations and scripts. As a particular example, the compiled program code 272A may provide weapon logic for the video game application instances 240A-240B, and the compiled program code 272B can provide red shirts for characters for the video game application instances 240A-240B.

To generate the binary 262A, the server 260 can access metadata 274 associated with the compiled program codes. The metadata 274 is stored by the computer system 270 and includes a manifest specifying a predefined list of executable combinations of the compiled program codes for the video game application instances 240A-240B. For example, the manifest may specify combinations of the compiled program codes that can be executed by particular operating systems (e.g., Linux, macOS, Windows, PlayStation OS/console, etc.). As an example, the manifest may indicate that compiled program codes 272A-272B are a combination of compiled program codes that are executable by a Windows operating system. Additionally or alternatively, the manifest may indicate source code assets that can be sent in a generic portable form which gets turned into program code that is executable in a target environment (e.g., optimized into a form that can be executed on a specific system). The metadata 274 can also specify a source code asset associated with each compiled program code and one or more properties for using the compiled program code. For example, the properties may include compatibility information between the compiled program codes for the video game application instances 240A-240B. That is, the properties may indicate that the compiled program code 272A is exchangeable (e.g., compatible) with a different compiled program code that provides different weapon logic.

The server 260 can also access a dependency graph 276 associated with the compiled program codes to generate the binary 262A. The dependency graph 276 indicates dependency information between the compiled program codes for the video game application instances 240A-240B. For example, the dependency graph 276 may indicate that the compiled program code 272B is dependent on another compiled program code and, thus, cannot be executed without the other compiled program code being included in the binary.

By using the metadata 274 and the dependency graph 276, the server 260 can request a combination of compiled program codes that are indicated by the manifest as being compatible with an operating system of an executing device (e.g., video game consoles 210A-210B). For example, upon determining that the operating system of the video game consoles 210A-210B is Windows and that the metadata 274 indicates that the compiled program codes 272A-272B are compatible with Windows, the server 260 can request the compiled program codes 272A-272B for incorporating into the binary 262A. The server 260 can also request any additional compiled program codes that the compiled program codes 272A-272B are indicated as being dependent on based on the dependency graph 276. The metadata 274 may indicate a checksum identifier for each of the compiled program codes, so the server 260 can request the compiled program code 272A by using a first checksum identifier associated with the compiled program code 272A and can request the compiled program code 272B by using a second checksum identifier associated with the compiled program code 272B.

The video game application instances 240A-240B can each include a linker or can make an application programming instance call to a linker that combines the object code of the compiled program codes 272A-272B with libraries and modules to create the binary 262A as an executable file. So, the video game application instances 240A-240B can link the compiled program code 272A with the compiled program code 272B in the binary 262A. The server 260 can then execute the video game application instance 240A on the video game console 210A based on the binary 262A and the video game application instance 240B on the video game console 210B based on the binary 262A.

During execution of the video game application instances 240A-240B, the server 260 can receive a program code patch 264 for the binary 262A. The server 260 may be notified that the program code patch 264 includes a compiled program code 272C that is to replace the compiled program code 272A in the binary 262A. For example, the compiled program code 272C may be for a mud texture. In other examples, the program code patch 264 may be to replace the compiled program code 272B or to be added to the binary 262A. The notification of the program code patch 264 can include an identification of a checksum identifier associated with the compiled program code 272C. So, the server 260 can request the program code patch 264 for download from the computer system 270 using the checksum identifier, the metadata 274, and the dependency graph 276.

In an example, the server 260 receives the program code patch 264 including the compiled program code 272C. The compiled program code 272C can be received based on the metadata 274 and the dependency graph 276, and the server 260 can update the binary 262A to include the compiled program code 272C based on the metadata 274 and the dependency graph 276. For example, since the program code patch 264 is to replace the compiled program code 272A with the compiled program code 272C and the metadata 274 and the dependency graph 276 indicate how the cached compiled program codes can be linked, the server 260 can update the binary 262A to include the compiled program code 272C based on the metadata 274 and the dependency graph 276. For instance, the video game application instances 240A-240B can remove a portion of the binary 262A that is associated with the compiled program code 272A and add a portion of binary (or replace the portion) with the compiled program code 272C, resulting in binary 262B that is different from the binary 262A. This update to the binary 262B can occur while the video game application instances 240A-240B continue to execute, such that user play is not disrupted.

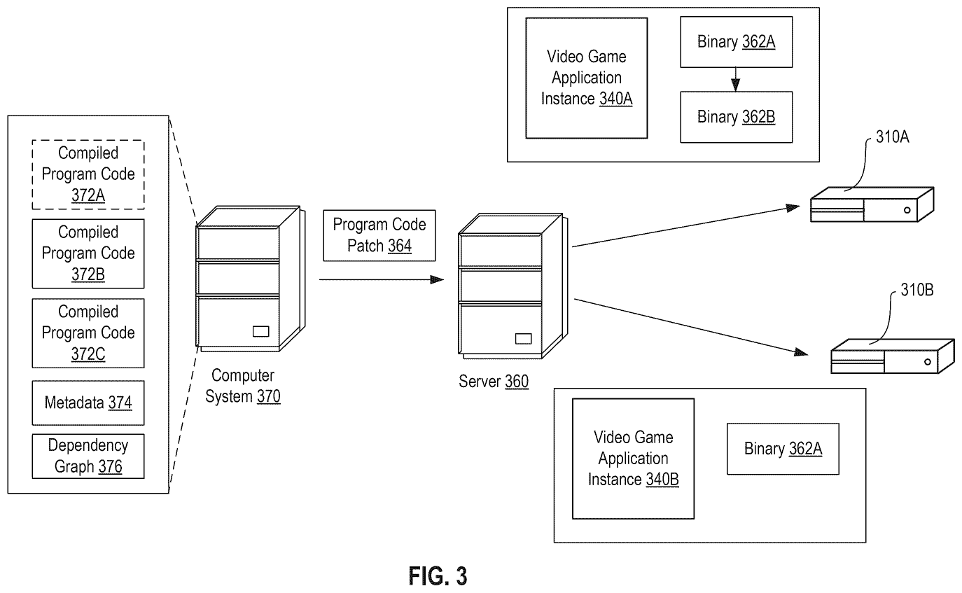

FIG. 3 illustrates an example of updating a binary for a single instance of a video game application while multiple instances are executing, according to embodiments of the present disclosure. A server 360, which is an example of the server 160 in FIG. 1 can include a binary 362A for a video game application (e.g., video game application 140 in FIG. 1). The binary 362A can include compiled program codes 372A-372B. The server 360 can execute multiple instances of the video game application. For example, in FIG. 3 the server 360 is illustrated as executing video game application instance 340A at video game console 310A and video game application instance 340B at video game console 310B. The binary 362A may be generated for execution as described herein above in FIG. 2.

During execution of the video game application instances 340A-340B, the server 360 can receive a program code patch 364 for the binary 362A. The server 360 may be notified that the program code patch 364 includes a compiled program code 372C that is to replace the compiled program code 372A in the binary 362A. For example, the compiled program code 372C may be for boss logic that is to replace boss logic of the compiled program code 372A. The notification of the program code patch 264 can include an identification of a checksum identifier associated with the compiled program code 372C. So, the server 360 can request the program code patch 364 for download from the computer system 370 using the checksum identifier, metadata 374 associated with the video game application instances 340A-340B, and a dependency graph 376 for the video game application instances 340A-340B.

In an example, the server 360 receives the program code patch 364 including the compiled program code 372C. The compiled program code 372C can be received based on the metadata 374 and the dependency graph 376, and the server 360 can update the binary 362A to include the compiled program code 372C based on the metadata 374 and the dependency graph 376. Prior to updating the binary 362A, the server 360 can determine whether the compiled program code 372A is in use by the video game application instances 340A-340B. To do so, the server 340 can determine whether the video game application instances 340A-340B are currently executing the compiled program code 372A (e.g., by determining whether the boss associated with the boss logic is being played). If the server 360 determines that the compiled program code 372A is not in use, the server 360 can replace the compiled program code 372A with the compiled program code 372C.

In an example, the server 360 may determine that the compiled program code 372A is not in use by the video game application instance 340A, but the compiled program code 372A is in use by the video game application instance 340B. So, the server 360 can replace the compiled program code 372A with the compiled program code 372B for the video game application instance 340A based on the compiled program code 372A not being in use by the video game application instance 340A. That is, the server 360 can instruct or cause the video game application instance 340A (e.g., a linker of the video game application instance 340A) to remove a portion of the binary 362A that is associated with the compiled program code 372A and add a portion of binary (or replace the portion) with the compiled program code 372C, resulting in binary 362B that is different from the binary 362A. This update to the binary 362B can occur while the video game application instance 340A continues to execute, such that user play is not disrupted.

The server 360 can wait to update the binary 362A for the video game application instance 340B until the compiled program code 372A is no longer in use by the video game application instance 340B. So, while the video game application instance 340A executes based on the binary 362B with the compiled program code 372C, the video game application instance 340B can continue executing based on the binary 362A with the compiled program code 372A. Once the server 360 determines that the compiled program code 372A is no longer in use by the video game application instance 340B, which may be after replacing the compiled program code 372A with the compiled program code 372C for the video game application instance 340A, the server 360 can replace the compiled program code 372A with the compiled program code 372C for the video game application instance 340B.

In an example, while the compiled program code 372A is in use by the video game application instance 340B, the server 360 may incorporate the compiled program code 372C into the binary 362A, while maintaining the compiled program code 372A in the binary 362A. Then, when the compiled program code 372A is no longer in use, the server 360 can remove the compiled program code 372A from the binary 362A while leaving the compiled program code 372C.

In an example, only a subset of the binaries executing on the server 360 may be updated at a time for other reasons than the compiled program code associated with the program code patch being in use. For example, if there is a change to compiled program code, the changed compiled program code may only be incorporated into a subset of the binaries until the server 360 verifies that the changed compiled program code does not introduce any issues into the execution of the video game application. Once the changed compiled program code is determined to be safe, the server 360 can incorporate the changed compiled program code into remaining binaries. As another example, the server 360 may determine a preference of users between a first compiled program code and a second compiled program code that perform a similar function (e.g., provide different character shirt colors). The server 360 can generate a first binary including the first compiled program code for execution for a first subset of video game application instances and can generate a second binary including the second compiled program code for execution at a second subset of video game application instances. Once the preference of the users is determined, the server 360 can then update either the first subset or the second subset to include the first or second compiled program code that is associated with the preference.

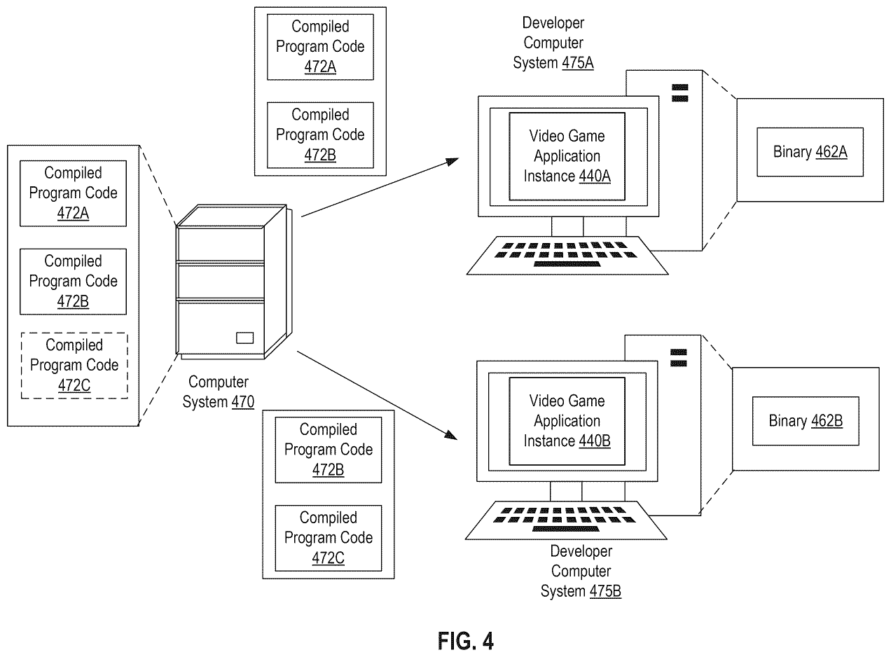

FIG. 4 illustrates an example of a development environment for video game applications, according to embodiments of the present disclosure. The development environment includes developer computer systems 475A-475B, which may be the same or different computer systems. The developer computer systems 475A-475B are communicatively coupled to a computer system 470 that stores compiled program codes 472A-472C, which each correspond to a source code asset. During development of a video game application, a game developer may want to determine which compiled program code for a particular attribute of the video game application outperforms other compiled program codes for the same attribute. The game developer, or a set of game developers, can use the developer computer systems 475A-475B to test each compiled program code for the attribute to determine which one performs best.

In an example, compiled program code 472A and compiled program code 472C may be associated with a same attribute of the video game application. For example, compiled program code 472A and compiled program code 472C can both be a shader program for the video game application. To test which of the compiled program code 472A or the compiled program code 472C performs better (e.g., fewer glitches or bugs), binaries 462A-462B can be generated for instances of the video game application that include the compiled program code 472A and that include the compiled program code 472C. All other portions of the binaries 462A-462B can be the same other than having the compiled program code 472A or the compiled program code 472C. For example, binary 462A can include the compiled program code 472A and compiled program code 472B, which may be associated with a type of weapon in the video game application. In contrast, binary 462B can include the compiled program code 472C and the compiled program code 472B. So, the developer computer system 475A can execute a video game application instance 440A based on the binary 462A with a first shader program and the developer computer system 475B can execute a video game application instance 440B based on the binary 462B with a second shader program.

Based on the executions of the binaries 462A-462B, a developer may determine that the binary 462A with the compiled program code 472A outperforms the binary 462B with the compiled program code 472C. So, the developer can provide a user input at either of the developer computer systems 475A-475B indicating that the compiled program code 472A is to be used in the video game application rather than the compiled program code 472C. As a result, the compiled program code 472C can be removed from the computer system 470.

In an example, the compiled program codes 472A-472C can be used for A/B testing, where different sets of users receive different combinations of the compiled program codes 472A-472C to determine which is preferable. For example, a first set of users can receive compiled program codes 472A-472B and a second set of users can receive compiled program codes 472B-472C. Upon executing respective binaries and playing the portion of the video game application associated with the compiled program codes 472A-472C, the users can provide feedback about how they liked their version. Based on the feedback, the preferred compiled program code between the compiled program codes 472A and 472C can be determined.

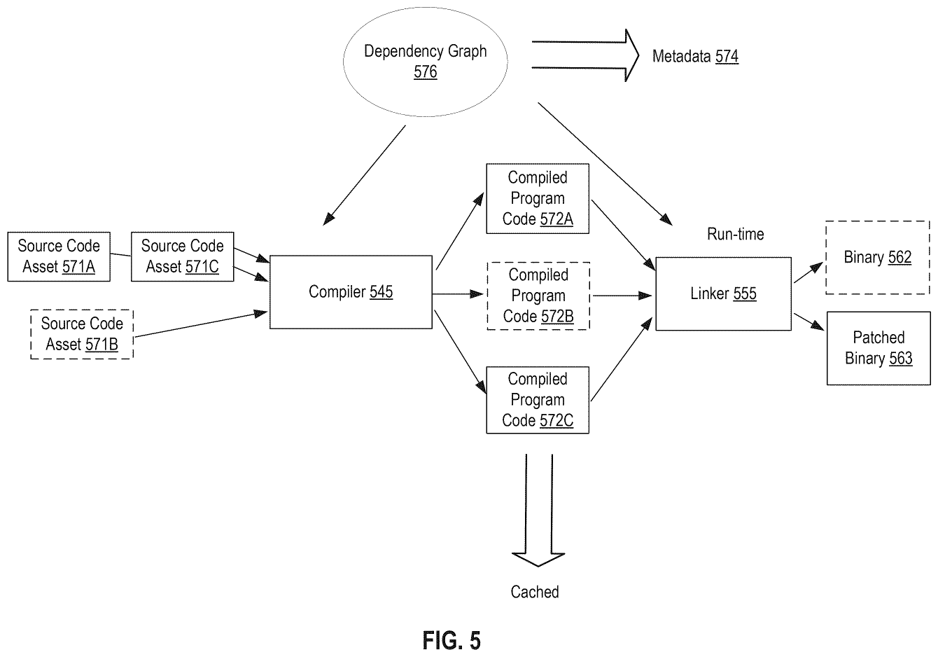

FIG. 5 illustrates an example of a diagram for video game binary generation and patching from source code assets, according to embodiments of the present disclosure. To generate a binary 562 for a video game application, a computer system (e.g., computer system 270 in FIG. 2) can receive source code assets 571A-571B defining logic for attributes of the video game application. These source code assets 571A-571B are compiled by a compiler 545 that is remote from the video game application, such as on the computer system. The compiler 545 generates a compiled program code for each source code asset. So, the compiler 545 can generate compiled program code 572A for source code asset 571A and can generate compiled program code 572B for source code asset 571B. For example, if source code asset 571A is a Photoshop file for a texture attribute, the compiler 545 generates the compiled program code 572A as a compilation unit such as an object file that can be used on a graphics processing unit (GPU). The compilation can involve flattening the layers of the Photoshop file into a single texture and performing compression so that the compilation unit can be used efficiently by the GPU. The compiled program codes 572A-572B are cached by the computer system.

At the time of compilation, metadata 574 and a dependency graph 576 are generated for the video game application. For a given compiled program code, the metadata 574 indicates the source code asset that the compiled program code corresponds to, how the compiled program code was generated, and properties for executing the compiled program code. The properties can indicate an operating system, a type of GPU, other characteristics for executing the compiled program code. The metadata 574 can also include a manifest that specifies predefined compatible combinations of compiled program codes for the video game application. The dependency graph 576 provides dependency information about how the compiled program codes can go together in the video game application. For instance, the dependency graph 576 can indicate that compiled program code 572B is has a dependency on another compiled program code. The dependency graph 576 and the metadata 574 are maintained by the computer system.

At run-time of the video game application by a server (e.g., server 160 in FIG. 1), a linker 555 associated with the video game application receives the compiled program codes 572A-572B for building the binary 562 for the video game application. The linker 555 uses the dependency graph 576 and the metadata 574 to determine how to link together the compiled program codes 572A-572B to create the binary 562. The server then executes video game application based on the binary 562.

During execution of the binary 562, source code asset 571C may be created to replace source code asset 571B, as indicated by the dashed box for the source code asset 571B. The compiler 545 generates compiled program code 572C for the source code asset 571C and caches the compiled program code 572C with the compiled program codes 572A-572B. In addition, the dependency graph 576 and the metadata 574 are updated to include information related to the compiled program code 572C.

While the video game application continues to execute, the server receives an indication that the compiled program code 572C is to replace the compiled program code 572B in the binary 562. So, the server retrieves the compiled program code 572C from the cache and the linker 555 updates the binary 562 to create a patched binary 563 using the compiled program code 572C, the dependency graph 576, and the metadata 574. The patched binary 563 includes the compiled program code 572A and the compiled program code 572C. Because the compiled program code 572B is cached, if the server determines that the patched binary 563 is to be reverted to the binary 562 that includes the compiled program code 572B instead of the compiled program code 572C, the server can retrieve the compiled program code 572B from the cache and the linker 555 can generate the binary 562 using the compiled program code 572B, the dependency graph 576, and the metadata 574.

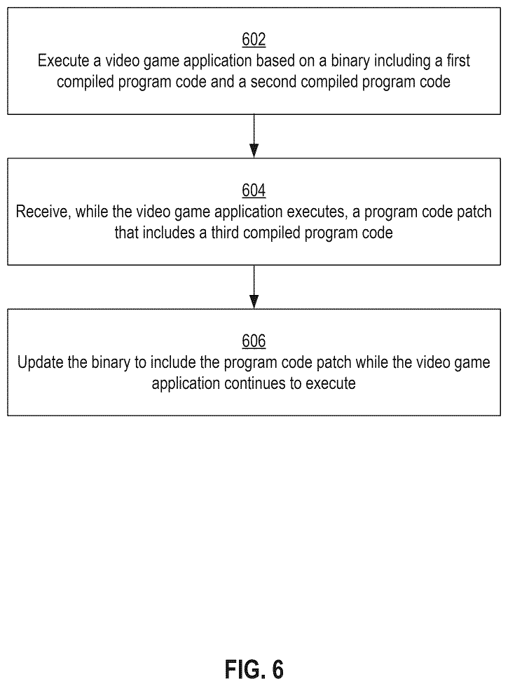

FIG. 6 illustrates an example flow for a process of updating application binary during video game execution, according to embodiments of the present disclosure. The operations of the flow can be implemented as hardware circuitry and/or stored as computer-readable instructions on a non-transitory computer-readable medium of a computer system, such as any of the computer systems described herein (e.g., server 160 in FIG. 1). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, the flow includes operation 602, where the computer system executes a video game application based on a binary including a first compiled program code and a second compiled program code. The first compiled program code can be a first object file or other compilation unit compiled from a first source code asset associated with logic for a first attribute of the video game application. The second compiled program code can be a second object file or other compilation unit compiled from a second source code asset associated with logic for a second attribute of the video game application.

In an example, the flow includes operation 604, where the computer system receives, while the video game application executes, a program code patch that includes a third compiled program code. The program code patch may be to replace the first or second compiled program code or to be added to the binary. For example, the third compiled program code may be a third object file or other compilation unit compiled from a third source code asset associated with logic for the second attribute of the video game application. So, the program code patch can be for replacing the second compiled program code in the binary. The program code patch can be received based on metadata and a dependency graph associated with the video game application.

In an example, the flow includes operation 606, where the computer system updates the binary to include the program code patch while the video game application continues to execute. The computer system can request and receive the third program code based on a checksum identifier associated with the third program code. If the program code patch is for replacing the second compiled program code in the binary, the video game application can update the binary by unlinking the second compiled program code in the binary and link the third compiled program code with the first compiled program code in the binary. Prior to updating the binary, the computer system can determine that the compiled program code being replaced is not in use by the video game application.

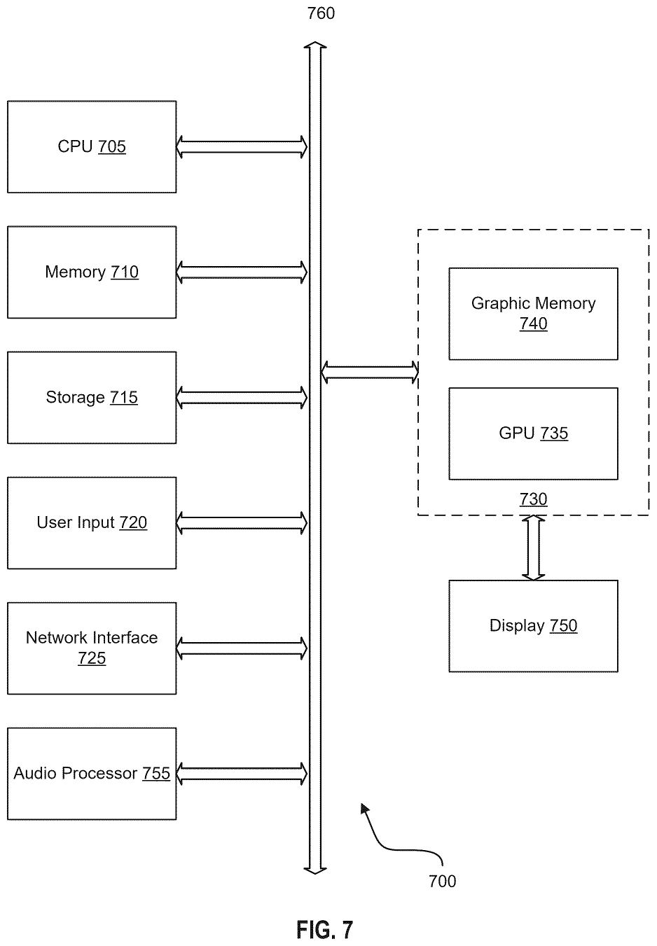

FIG. 7 illustrates an example of a hardware system suitable for implementing a computer system, according to embodiments of the present disclosure. The computer system 700 represents, for example, a video game system, a backend set of servers, or other types of a computer system. The computer system 700 includes a central processing unit (CPU) 705 for running software applications and optionally an operating system. The CPU 705 may be made up of one or more homogeneous or heterogeneous processing cores. Memory 710 stores applications and data for use by the CPU 705. Storage 715 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 720 communicate user inputs from one or more users to the computer system 700, examples of which may include keyboards, mice, thumbsticks, touch pads, touch screens, still or video cameras, and/or microphones. Network interface 725 allows the computer system 700 to communicate with other computer systems via an electronic communications network and may include wired or wireless communication over local area networks and wide area networks such as the Internet. An audio processor 755 is adapted to generate analog or digital audio output from instructions and/or data provided by the CPU 705, memory 710, and/or storage 715. The components of computer system 700, including the CPU 705, memory 710, data storage 715, user input devices 720, network interface 725, and audio processor 755 are connected via one or more data buses 760.

A graphics subsystem 730 is further connected with the data bus 760 and the components of the computer system 700. The graphics subsystem 730 includes a graphics processing unit (GPU) 735 and graphics memory 740. The graphics memory 740 includes a display memory (e.g., a frame buffer) used for storing pixel data for each pixel of an output image. The graphics memory 740 can be integrated in the same device as the GPU 735, connected as a separate device with the GPU 735, and/or implemented within the memory 710. Pixel data can be provided to the graphics memory 740 directly from the CPU 705. Alternatively, the CPU 705 provides the GPU 735 with data and/or instructions defining the desired output images, from which the GPU 735 generates the pixel data of one or more output images. The data and/or instructions defining the desired output images can be stored in the memory 710 and/or graphics memory 740. In an embodiment, the GPU 735 includes 3D rendering capabilities for generating pixel data for output images from instructions and data defining the geometry, lighting, shading, texturing, motion, and/or camera parameters for a scene. The GPU 735 can further include one or more programmable execution units capable of executing shader programs.

The graphics subsystem 730 periodically outputs pixel data for an image from the graphics memory 740 to be displayed on the display device 750. The display device 750 can be any device capable of displaying visual information in response to a signal from the computer system 700, including CRT, LCD, plasma, and OLED displays. The computer system 700 can provide the display device 750 with an analog or digital signal.

In accordance with various embodiments, the CPU 705 is one or more general-purpose microprocessors having one or more processing cores. Further embodiments can be implemented using one or more CPUs 705 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
executing a video game application based on a binary including a first compiled program code and a second compiled program code;
receiving, while the video game application executes, a program code patch that includes a third compiled program code to replace the first or second compiled program code or to be added to the binary; and
updating the binary to include the program code patch while the video game application continues to execute.

2. The computer-implemented method of claim 1, wherein the method further comprises:
receiving an identification of a checksum identifier associated with the third compiled program code; and
requesting the program code patch for download using the checksum identifier.

3. The computer-implemented method of claim 1, wherein the video game application links the first compiled program code and the second compiled program code in the binary.

4. The computer-implemented method of claim 1, wherein the first compiled program code and the second compiled program code are compiled by a compiler that is remote from the video game application.

5. The computer-implemented method of claim 1, wherein the program code patch is received based on metadata associated with the video game application and a dependency graph associated with the video game application, and wherein the method further comprises:
updating the binary based on the metadata and the dependency graph.

6. The computer-implemented method of claim 5, wherein the metadata associated with the video game application includes a manifest specifying a predefined list of executable combinations of compiled program codes for the video game application, wherein the metadata further specifies, for the first compiled program code, a source code asset associated with the first compiled program code and one or more properties for using the first compiled program code, and wherein the one or more properties indicate compatibility information between the first compiled program code and one or more other compiled program codes for the video game application.

7. The computer-implemented method of claim 5, wherein the dependency graph associated with the video game application indicates, for the first compiled program code, dependency information between the first compiled program code and one or more other compiled program codes for the video game application.

8. The computer-implemented method of claim 1, further comprising:
executing, on a server, a first instance of the video game application and a second instance of the video game application;
requesting, by the server, the third compiled program code associated with the program code patch;
receiving the third compiled program code; and
updating the first instance and the second instance using the third compiled program code.

9. The computer-implemented method of claim 8, wherein the third compiled program code is requested based on metadata associated with the video game application, a dependency graph associated with the video game application, and a checksum identifier of the third compiled program code.

10. The computer-implemented method of claim 8, wherein the third compiled program code is to replace the first compiled program code, and where in the method further comprises:
determining that the first compiled program code is not in use by the first instance of the video game application;
determining that the first compiled program code is in use by the second instance of the video game application; and
replacing the first compiled program code with the third compiled program code for the first instance based on the first compiled program code not being in use.

11. The computer-implemented method of claim 10, further comprising:
determining, subsequent to replacing the first compiled program code with the third compiled program code for the first instance, that the first compiled program code is not in use by the second instance of the video game application; and
replacing the first compiled program code with the third compiled program code for the second instance based on the first compiled program code not being in use.

12. The computer-implemented method of claim 1, wherein the third compiled program code is to replace the first compiled program code, and where in the method further comprises:
determining that the first compiled program code is not in use by the video game application; and
replacing the first compiled program code with the third compiled program code based on the first compiled program code not being in use.

13. A computer-readable storage medium having stored therein program code instructions that, when executed by a processor in a computer system, cause the processor to perform a method comprising:
executing a video game application based on a binary including a first compiled program code and a second compiled program code;
receiving, while the video game application executes, a program code patch that includes a third compiled program code to replace the first or second compiled program code or to be added to the binary; and
updating the binary to include the program code patch while the video game application continues to execute.

14. The computer-readable storage medium of claim 13, wherein the method further comprises:
receiving an identification of a checksum identifier associated with the third compiled program code; and
requesting the third program code for download using the checksum identifier.

15. The computer-readable storage medium of claim 13, wherein the video game application links the first compiled program code and the second compiled program code in the binary.

16. The computer-readable storage medium of claim 13, wherein the first compiled program code and the second compiled program code are compiled by a compiler that is remote from the video game application.

17. The computer-readable storage medium of claim 13, wherein the program code patch is received based on metadata associated with the video game application and a dependency graph associated with the video game application, and wherein the method further comprises:
updating the binary based on the metadata and the dependency graph.

18. The computer-readable storage medium of claim 13, further comprising:
executing, on a server, a first instance of the video game application and a second instance of the video game application;
requesting, by the server, the third compiled program code associated with the program code patch;
receiving the third compiled program code; and
updating the first instance and the second instance using the third compiled program code.

19. The computer-readable storage medium of claim 18, wherein the third compiled program code is requested based on metadata associated with the video game application, a dependency graph associated with the video game application, and a checksum identifier of the third compiled program code.

20. A system, comprising:
one or more memories configured to store computer-executable instructions;
one or more processors configured to access the one or more memories and execute the computer-executable instructions to at least:
execute a video game application based on a binary including a first compiled program code and a second compiled program code;
receive, while the video game application executes, a program code patch that includes a third compiled program code to replace the first or second compiled program code or to be added to the binary; and
update the binary to include the program code patch while the video game application continues to execute.
